(19) United States
(12) Patent Application Publication
(10) Pub. No.: US 2007/0210101 A1
(43) Pub. Date: Sep. 13, 2007

(54) Vapour Dispensing Device

(75) Inventors: Geoffrey Robert Hammond, Hull (GB); Shaun Rymer, Hull (GB)

Correspondence Address: NORRIS, MCLAUGHLIN & MARCUS, 875 THIRD AVE, 18TH FLOOR, NEW YORK, NY, 10022, US

(73) Assignee: Reckitt Benckiser (UK) Limited, Slough, Berkshire (GB)

(21) Appl. No.: 10/544,026

(22) PCT Filed: Jan. 27, 2004
(86) PCT No.: PCT/GB04/00336

§ 371 Date: Feb. 21, 2006

(30) Foreign Application Priority Data
Feb. 4, 2003 (GB) 0302462.7

(51) Int. Cl. B05B 1/00

(52) U.S. Cl. 222/3

(57) ABSTRACT

A vapour dispensing device in which a flowable substance 5 to be vaporised is dispensed from a reservoir 4 onto an emanator pad 9. The reservoir is provided with an outlet 6 and an air inlet 7. These are positioned in relationship to the emanator pad such that some of the substance leaving outlet 6 is conveyed by the emanator pad into the vicinity of the air inlet. When the pad adjacent to the air inlet is wetted, it becomes impermeable to air. As no further air can enter the reservoir 4, the vacuum in the head space prevents the dispensing of further substance from the outlet 6. This causes a drying of the emanator pad 9 which then becomes air permeable allowing further flow from the reservoir. This effectively provides a negative feedback arrangement which regulates the flow from the reservoir.

The present invention relates to the field of vapour dispensing. It relates, more particularly, to a device for diffusing a fragrance into the surrounding air. The device of the invention, however, can also be used for the diffusion of other active volatile agents, such as insect repellent or attractant, insecticide, deodorising or sanitising agent, amongst others.

Conventional devices for dispensing perfumed vapours fall into two categories, namely electrical and non-electrical. Electrical devices have a better performance than non-electrical devices as they can be controlled in order to provide a substantially constant output throughout the lifetime of the device. However, these devices have a drawback in that are either required to be plug-in devices, in which case their use is limited to situations where a socket is available, or they require a battery which is expensive.

Non-electrical devices, by contrast, can be used anywhere as they do not require a source of power. However, these devices rely on the evaporation of a substance from a source of the substance, which is difficult to regulate. Such devices, therefore, tend to emit substantially more fragrance towards the beginning of their life than towards the end. This is undesirable as it shortens the useful life of the device by excess use of fragrance early on, and the gradual tailing off of the emission of fragrance makes it hard for a consumer to appreciate when the device has reached the end of its useful life.

The present invention aims to provide a device which provides a substantially constant output similar to that of an electrical device while maintaining the convenience of a non-electrical device.

According to the present invention a vapour dispensing device comprises a closed reservoir containing a liquid substance to be vaporised, an outlet from the reservoir, an air inlet into the reservoir and an emanator pad which is positioned so as to have a portion covering the air inlet, and positioned with respect to the outlet so that, in use, it conveys some of the substance from the outlet to the portion covering the air inlet, wherein, when the substance is present at the portion covering the air inlet it becomes impermeable to air.

This arrangement operates as follows. When the device is initiated, the vaporisable substance is dispensed from the outlet onto the emanator pad where it is evaporated into the ambient air. As the level of the substance in the sealed reservoir falls, a space is created at the top of the reservoir producing a vacuum which tends to draw air in through the air inlet. At the same time, the substance is conveyed from the emanator pad to the portion of the emanator pad covering the air inlet. Once this portion becomes wetted with the substance, the air inlet is sealed. Any further fall in the level of the substance in the reservoir will tend to create a vacuum at the top of the reservoir. This will prevent any more of the substance from leaving the reservoir. This, in turn, causes the emanator pad to dry up which then allows air to begin to flow in through the air inlet causing further flow of the substance from the reservoir.

This essentially creates a negative feed-back loop in which the flow of the substance from the reservoir triggers a chain of events which prevents its further flow. It should be noted that these events occur on a very small scale, such that there is no noticeable drying of the emanator pad. Instead, a slight change in the dryness of the emanator pad will be sufficient to allow air in through the inlet thus causing further flow.

The net effect of this arrangement is not just a slowing down of the flow of the product from the reservoir, but it also provides a way of providing a more constant flow from the reservoir. Under normal circumstances, where such a device relies upon a gravity driven flow from a reservoir, the device will inevitably be fastest initially as the hydrostatic pressure is greatest at this time, and will fall off over time as the hydrostatic pressure falls. This effect is, however, counteracted by the negative feed back mechanism referred to above.

Some success has been achieved by having the inlet and the outlet in a side-by-side relationship. It is believed that it may also be possible to position the air inlet elevationally below the outlet if the air inlet is provided with a membrane which is impermeable to the substance. Also, both the air inlet and the outlet may be covered by membranes, in which case, the inlet will be covered with a more porous membrane. However, preferably, the air inlet is above the outlet.

The outlet and air inlet may be spaced some distance apart, provided that the emanator pad is able to convey the product from the outlet to the air inlet. However, preferably the outlet and air inlet are adjacent to one another as this provides an improved response time.

The outlet and air inlet may be provided in the same aperture into the reservoir. In this case, the aperture is preferably elongate in the vertical direction and preferably has a maximum dimension of at least 1 mm and more preferably at least 3 mm. However, preferably the air inlet and outlet are separate apertures, and preferably have a diameter of at least 1 mm.

The present invention also extends to a method of dispensing a vaporisable liquid substance from a sealed reservoir containing the substance, the method comprising the steps of flowing the substance from the reservoir, allowing air into the reservoir through an air inlet to promote the flow of the substance from the reservoir, and conveying at least a portion of the substance which has left the reservoir to the air inlet to block the flow of air into the reservoir through the air inlet and prevent further flow of the substance from the reservoir.

Examples of devices in accordance with the present invention will now be described with reference to the accompanying drawings, in which:

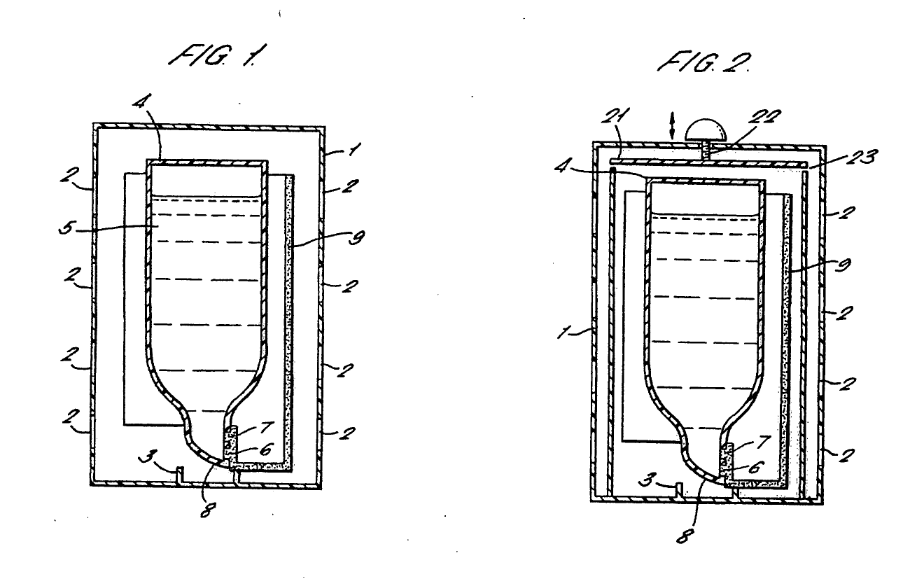

FIG. 1 is a schematic cross-section of a first device;

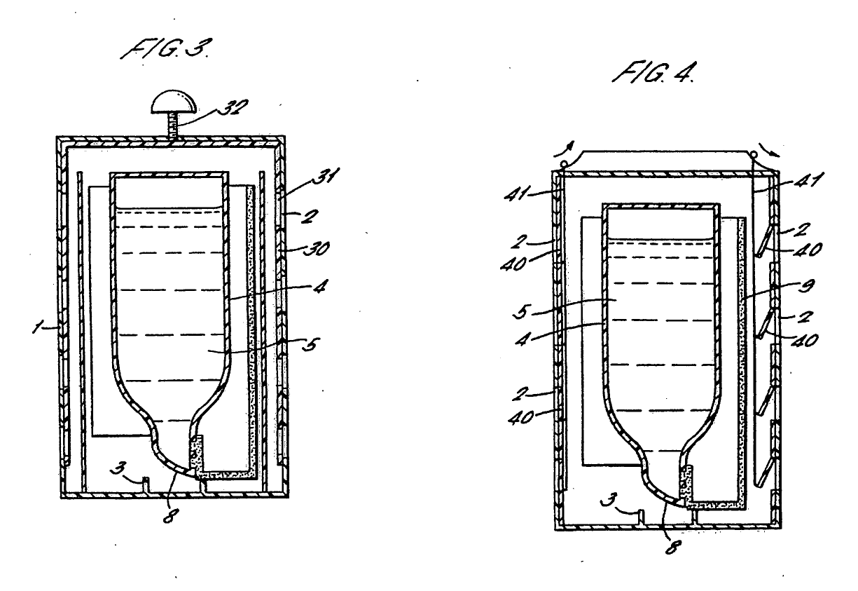

FIG. 2 is a view similar to FIG. 1 of a second device;

FIG. 3 is a view similar to FIG. 1 of a third device;

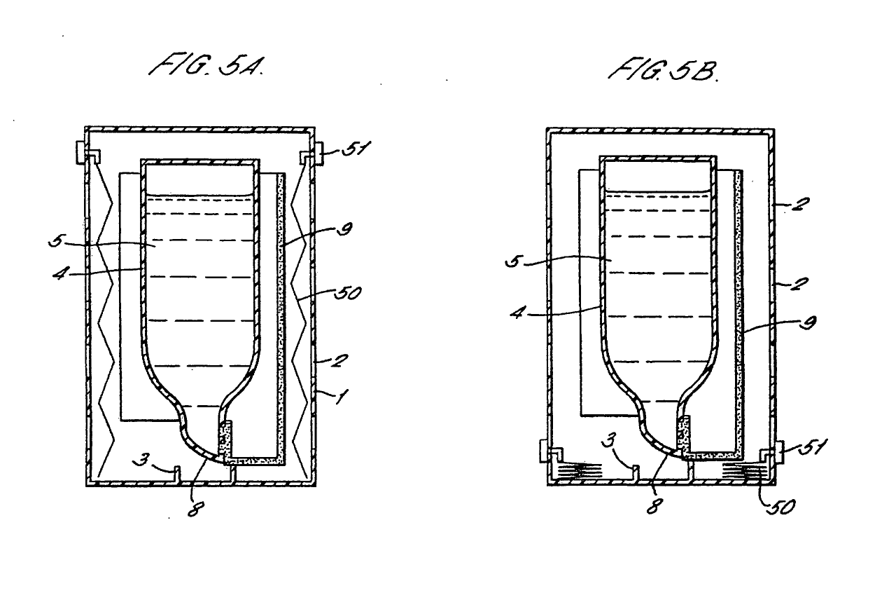

FIG. 4 is a view similar to FIG. 1 of a fourth device;

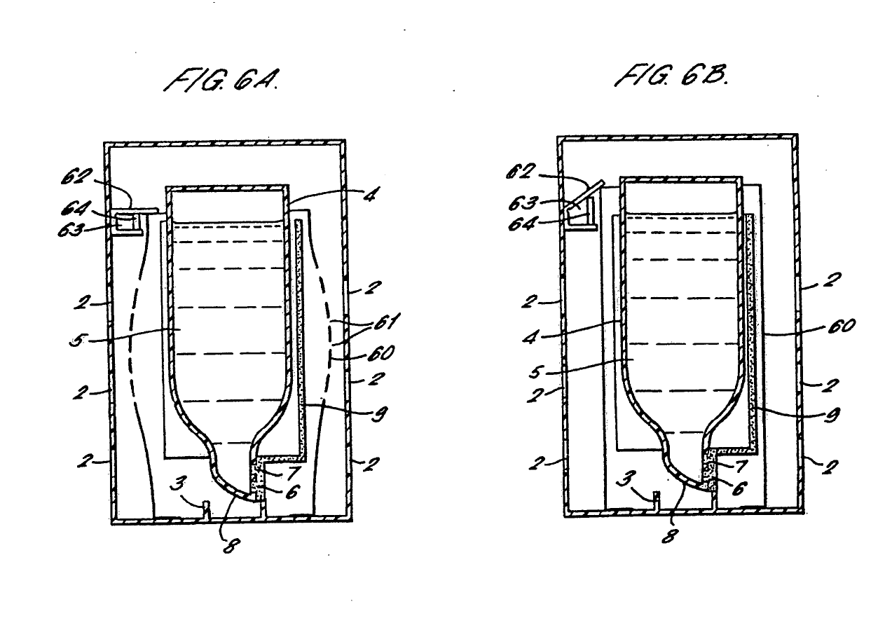

FIGS. 5A and 5B are views similar to FIG. 1 of a fifth device in closed and open configurations respectively;

FIG. 6A is a view similar to FIG. 1 of a sixth device;

FIG. 6B shows the device of FIG. 6A in a hotter environment;

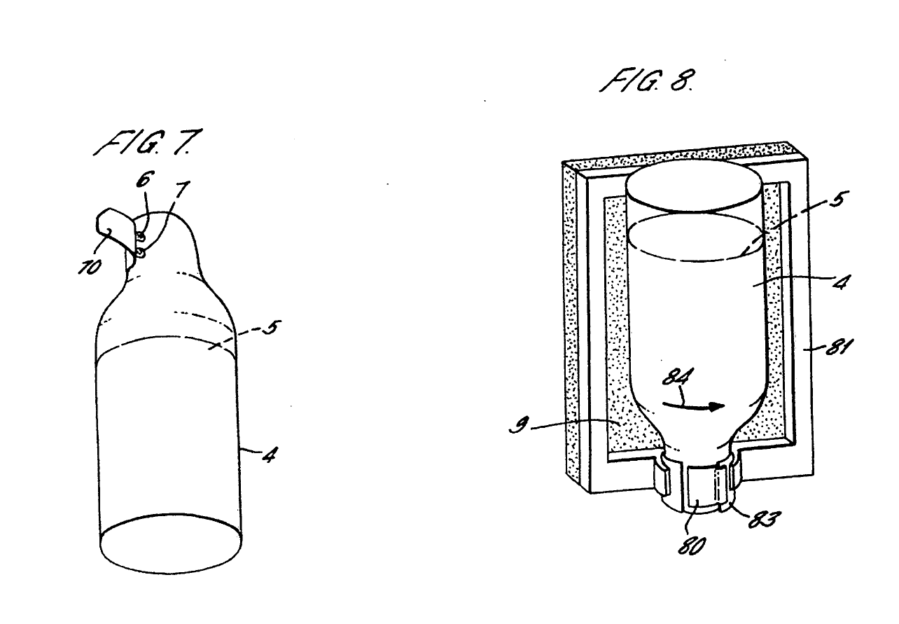

FIG. 7 is a perspective view of a reservoir of fragrance for the use in a device according to the invention;

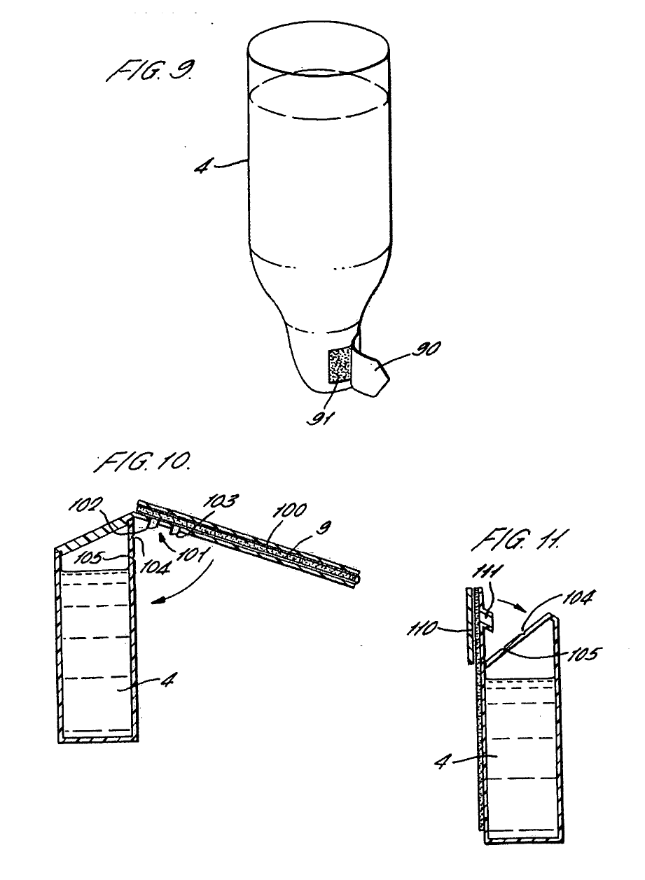

FIG. 8 is a perspective view of a reservoir and its mounting arrangement suitable for use in a device according to the invention;

FIG. 9 is a perspective view of an alternative arrangement of reservoir;

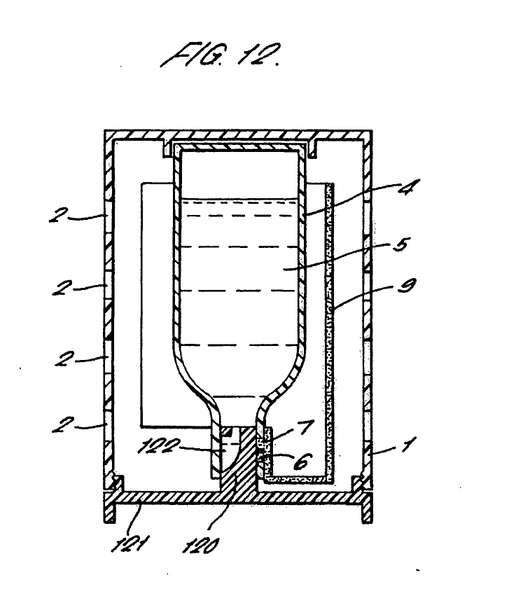

FIG. 10 is a cross-section through a reservoir showing an activation arrangement;

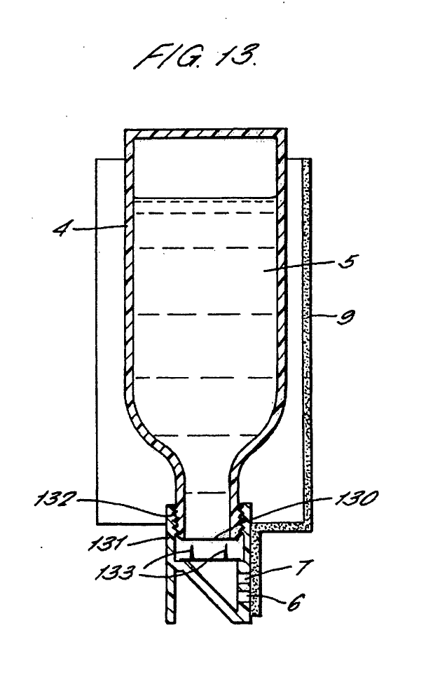

FIG. 11 is a view similar to FIG. 10 showing an alternative activation arrangement;

FIG. 12 is a view similar to FIG. 1 showing a seventh example;

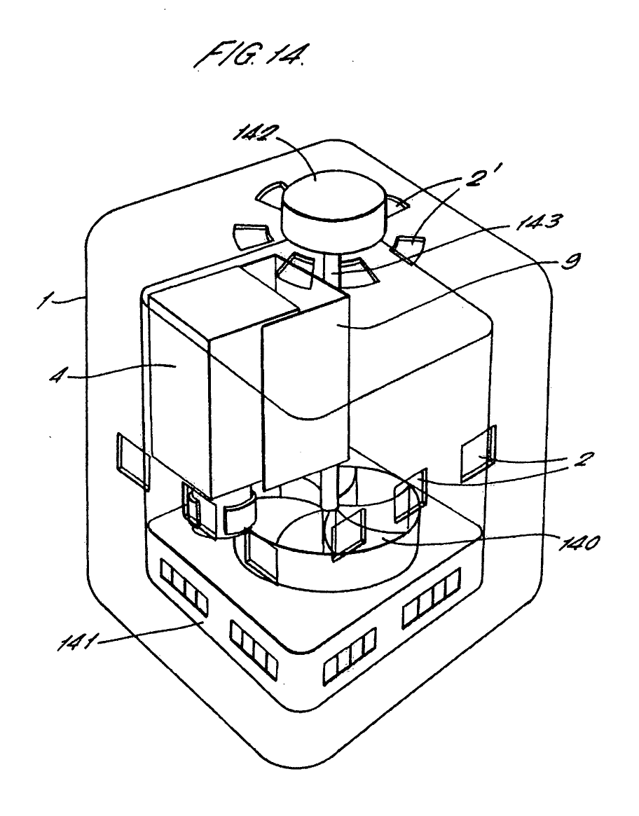

FIG. 13 is a view similar to FIG. 1 showing a eighth example;

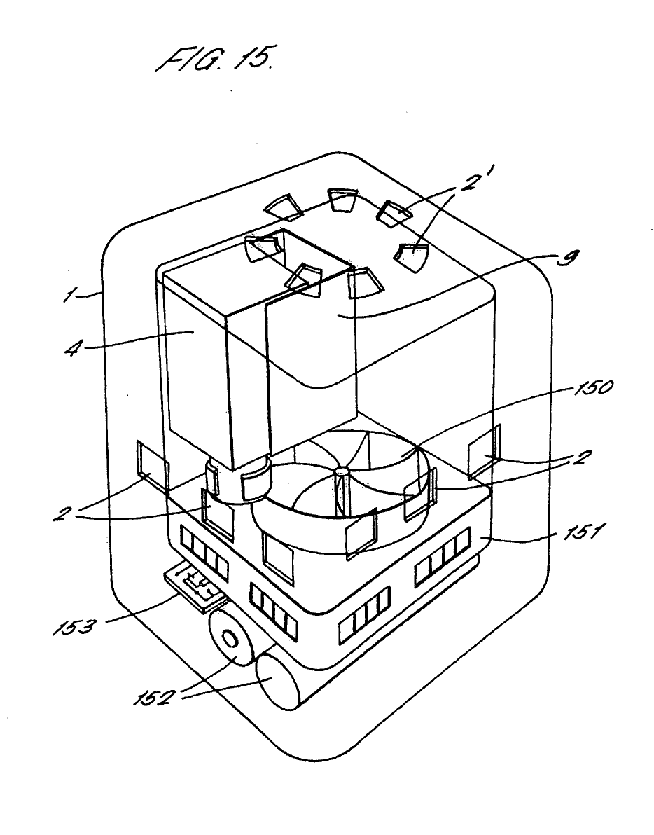

FIG. 14 is a perspective view showing a part of the housing broken away of an ninth example; and

FIG. 15 is a view similar to FIG. 14 showing a tenth example.

The basic device is shown in FIG. 1. This comprises a housing 1 having four vertically spaced apertures 2 on each side of the device. The housing 1 has a circular boss 3 in its base which receives a reservoir 4 of the liquid fragrance 5 to be dispensed. The housing also comprises a support frame (not shown) to hold the reservoir 4 in position. The reservoir 4 is a generally sealed container which has an outlet 6 adjacent to its lower end and an air inlet 7 above the outlet 6. The bottom face 8 of the reservoir 4 adjacent to the outlet 6 is inclined so as to direct the fragrance 5 towards the outlet 6 so that little or no fragrance is trapped within the reservoir 4. The reservoir 4 is generally surrounded by an emanator pad 9 which covers both the outlet 6 and the air inlet 7 and extends up around the main body of the reservoir and can be arranged to provide some assistance in the support of the reservoir 4.

Air freshening devices which emit liquid fragrance onto an emanator pad are well known in the art. The fragrance progressively leaks from the reservoir onto the pad, where it spreads across the pad and is ultimately evaporated. Under normal circumstances, the rate of emission of the vapour from the device is determined by the rate of evaporation of the fragrance from the emanator pad. The particular arrangement shown in FIG. 1 with the outlet 6 and air inlet 7 provides a manner of regulating the discharge of the fragrance 5 from the reservoir 4. In essence, when the fragrance is initially emitted from the outlet 6 of the reservoir 4, air enters the reservoir 4 through air inlet 7 thereby creating sufficient air reduction in the vacuum that exists in the reservoir above the fragrance to continue the flow of fragrance out of the outlet 6. The outlet 6, air inlet 7 and emanator pad 9 are arranged in such a way that as fragrance is discharged onto the emanator pad, some of the fragrance is absorbed up the emanator pad and into the vicinity of the air inlet 7. Once the emanator pad is sufficiently wetted in this region it becomes air-impermeable, preventing further flow of air into the reservoir 4 through the air inlet 7. Without this further airflow, sufficient pressure cannot be generated to release the fragrance 5 from the reservoir 4. This, in turn, causes a drying of the emanator pad to a point at which the emanator pad in the vicinity of the air inlet 7 becomes air permeable, at which time the fragrance again begins to flow from the outlet 6. This essentially provides a negative feedback mechanism which regulates the flow of the fragrance 5 from the reservoir 4.

The apertures 2 are sufficiently small that they restrict the flow of vapour from the housing 1 to a level less than the rate at which the fragrance is otherwise able to evaporate from the emanator pad 9. The result of this is that a saturated vapour forms within the housing. Under these conditions, the rate of emission of the vapour from the housing is determined by the size of the apertures 2 and the fragrance is unable to evaporate from the emanator pad 9 at a rate greater than the rate of flow of the vapour through the apertures. In practice, the saturated vapour forms quickly once operation of the device is initiated, even while only relatively little of the fragrance has been emitted onto the pad.

In testing, an exposed pad area of 90 cm² worked well with a total aperture area of 5 cm². Also, a 45 cm² pad with a 40 cm² total aperture area worked reasonably well.

A second example of the device is shown in FIG. 2 where the same reference numerals have been used to designate the same components. In FIG. 2 a cylindrical sleeve 20 surrounds the emanator pad 9. An adjustable disc 21 is positioned above the sleeve 20 by a screw threaded engagement 22 with the upper wall of the housing 1. This allows the height of disc 21 to be adjusted. In this case a saturated vapour is formed in the enclosure bounded by the sleeve 20 and disc 21 and the aperture which determines the rate of emission of the vapour from the device is the space 23 between the sleeve 20 and the disc 21. The size of this aperture 23 and hence the rate of emission from the device is set by the user adjusting the height of the disc 21.

A similarly adjustable arrangement is shown in FIG. 3. In this case, an inner sleeve 30 is provided with apertures 31 which generally correspond in size and position with the apertures 2 in the housing 1. The inner sleeve 30 is adjustable within the housing 1 by virtue of a screw threaded engagement 32 between the housing 1 and inner sleeve 30. Rotation of the screw threaded engagement 32 causes the inner sleeve 30 to be raised and lowered within the housing 1 by varying the degree of overlap between the apertures 2, 31. Thus, the amount of vapour leaving the housing 1 can be controlled.

FIG. 4 shows an alternative means of adjusting the size of the apertures 2. In this case, the adjustment is provided by a series of louvres 40, one of which is associated with each aperture 2. The louvres 40 are pivotly mounted to the housing 1. A linkage member 41 is pivotly linked to each louvre 40. Movement of the linkage 41 allows the louvres to be moved between a closed position as shown in the left-hand side of FIG. 4 and a fully open position shown on the right-hand side of FIG. 4. The degree of opening determines the degree of emission of the fragrance from housing 1.

FIGS. 5A and 5B show a further way of adjusting the size of the apertures 2. In this case, a concertina baffle 50 surrounds the emanator pad 9. The baffle is slidably supported on the housing 1 by a support 51 such that it can slide between an upper position as shown in FIG. 5A, in which the path from the emanator pad 9 to apertures 2 is entirely blocked, to a lower position shown in FIG. 5B, in which all of the apertures 2 are exposed.

A device capable of automatically varying the overall size of the apertures from the device in order to compensate for variations in the evaporation rate caused by temperature fluctuations is shown in FIGS. 6A and 6B. These two figures show the same device with FIG. 6A showing the device in a relatively low temperature, while FIG. 6B shows the same device in a higher temperature.

In this situation, a flexible sleeve 60 with a series of circumferentially extending slits 61 surrounds the reservoir 4. The top of the sleeve 60 is connected to a pivotable arm 62 which is part of a bracket 63 in which an expandable polymer element 64 is housed. The bracket is arranged such that, upon expansion of the expandable polymer element, the pivotable arm 62 is raised. As this is attached to the flexible sleeve 60, it raises the flexible sleeve 60 from the position shown in FIG. 6A to the position shown in FIG. 6B. In the FIG. 6A configuration, the wall of the flexible sleeve 60 is bowed, thereby causing the slits 61 to open, whereas, in the arrangement of FIG. 6B, the sides of the flexible sleeve 60 are straight causing the slits 61 to close up. In this arrangement, the saturated region is the region within the flexible sleeve 60. At lower temperatures, the bowed configuration of the sleeve 60 will allow more vapour to be emitted from the sleeve 60. An increase in the surrounding temperature which would otherwise serve to increase the rate of flow of the vapour through the slits, instead results a corresponding reduction in the size of the slits 61 thereby providing a device which is self regulating according to the temperature.

FIGS. 7, 8 and 9 all disclose ways in which the flow of fragrance 5 from the reservoir 4 can be initiated. In FIG. 7 the outlet 6 and air inlet 7 are covered by a foil 70 which is peeled off by a user before inserting the reservoir 4 into the housing 1 in the position shown in the previous figures.

FIG. 8 has a similar peelable foil 80. In this case the reservoir 4 is supported in a frame 81 which also supports the emanator pad 9. Part of the foil 80 is adhered to the reservoir 4 covering the outlet 6 and air inlet 7, and part is adhered to a surrounding portion 83 of the frame 81. Thus, rotation of the reservoir 4 by the user in the direction of arrow 84 will cause the foil 80 to be peeled off of the reservoir 4 hence exposing the outlet 6 and air inlet 7. A stop (not shown) may be provided to ensure that the reservoir 4 rotates to the correct rotational position.

The arrangement shown in FIG. 9 is similar to that shown in FIG. 7. However, in this case, behind the peelable foil 90 is an absorbent pad 91 which, in use, is sealed over the holes and forms a part of the emanator pad, although it does not necessarily have to be of the same material as the emanator pad. The peeling mechanism of FIG. 8 may be employed with the configuration of FIG. 9.

Alternative means of activating the reservoir 4 are shown in FIGS. 10 and 11. In both cases, the reservoir 4 in its inactivated condition is entirely sealed. A piecing attachment 100 is pivotably attached to the housing of the reservoir and includes a piecing element 101. This comprises two tubes 102, 103 with sharp extremities which are arranged to piece the reservoir 4 in the vicinity of weakened portions 104, 105. Thus, to activate the reservoir of FIG. 10, the user pivots the piercing attachment 100 so that it lies flat along the side of the reservoir 4. At this time, the tube 102 will penetrate the weakened portion 104 to form the liquid fragrance outlet, while tube 103 will penetrate weakened portion 105 to form the air inlet. Part of the emanator pad 9 is formed integrally with the piecing attachment 100.

A different configuration of piecing attachment 110 is shown in FIG. 11. This attachment has a larger single aperture 111. However, this follows the same principle as that shown in FIG. 10 and similar components are designated with the same reference numerals. In this case, the piercing attachment 110 engages with the inclined face of the reservoir 4, but it is believed that the operation of this arrangement is self evident from the description of FIG. 10.

FIG. 12 shows another means of activating the device. In this case, the bottom end of the reservoir 4 is open. This open end is plugged by a cylindrical plug 120 which is an integral moulding with a disc 121 rotatably attached to the lower end of the housing 1. The plug 120 is provided with an orifice 122 which opens at its top end into the interior of the reservoir 1, and at a side surface along an axial length which encompasses the outlet 6 and air inlet 7. In the configuration shown in FIG. 12 the orifice 122 faces the side wall of the reservoir 4 such that no flow will occur. However, it will be appreciated that when the plug 120 and the associated disc 121 are rotated through 180° from the configuration shown in FIG. 12, the orifice 122 will bring the inside of the reservoir 4 into communication with the outlet 6 and air inlet 7. For the purposes of this illustration, the orifice 122 has been shown 180° out of position with respect to the outlet 6 and air inlet 7. However, in practice, it is likely to be only a few degrees out of alignment with these orifices such that these will only have to rotate the disc 121 through a small angle to activate the device. This arrangement also has the benefit that a user can rotate the disc 121 back to the deactivated position thereby preventing further flow of fragrance from the reservoir 4. Alternatively, the plug may be part of a frame supporting the pad, rather than part of the housing.

In the arrangement shown in FIG. 13, the bottom end of the reservoir 4 is sealed with a foil 130 or some other membrane. The bottom end of the reservoir 4 engages with a stationary housing 131 which is provided with the outlet 6 and air inlet 7. The engagement between the reservoir 4 and housing 130 takes the form of a screw thread 132. At least one spike 133 is arranged in the frame 130 such that, when the reservoir 4 is screwed or pushed into the housing 131, the foil 130 is pierced by the spikes 133, thereby releasing the fragrance 5 from the reservoir 4. as an alternative to the spikes 133, an annular cutting element may be provided.

FIG. 14 is a perspective view of a device incorporating a fan. The housing 1 and reservoir 2 are generally as described in the previous examples. The housing 1 has additional openings 2′ in its upper surface. The reservoir 4 is partially surrounded by the emanator pad 9. A fan 140 is supported on a base 141 such to be rotatably about a vertical axis. A plunger 142 projects from the top of the housing 1. The plunger 142 is coupled by a shaft 143 to the fan 140 by a coupling (not shown) which converts linear motion of the plunger 142 into rotary motion of the fan 140. Thus, when a user requires a boost of fragrance from the device, the plunger 142 is depressed causing rotation of the fan which draws air in through holes in the base, thereby increasing the flow of vapour through the holes 2, 2′. This effectively expels saturated air from the housing 1 and replaces it with unsaturated air.

A similar fan arrangement is shown in FIG. 15. In this case a fan 150 is supported on base 151. The fan is an electric fan powered by batteries 152 under the control of control means 153. The control means may be set up to operate the fan at various intervals throughout the day. Alternatively, a switch may be provided in the housing 1 allowing the user to switch the fan on manually to provide the boost of fragrance.

1. A vapour dispensing device comprising a closed reservoir containing a liquid substance to be vaporised, an outlet from the reservoir, an air inlet into the reservoir and an emanator pad which is positioned so as to have a portion covering the air inlet, and positioned with respect to the outlet so that, in use, it conveys some of the substance from the outlet to the portion covering the air inlet, wherein, when the substance is present at the portion covering the air inlet it becomes impermeable to air.

2. A device according to claim 1, wherein the air inlet is above the outlet.

3. A device according to claim 1, wherein the outlet and air inlet are adjacent to one another.

4. A device according to claim 1, wherein the air inlet and outlet are separate apertures.

5. A device according to claim 4, wherein the air inlet and outlet each have a diameter of at least 1 mm.

6. A device according to claim 1, when the outlet and air inlet are provided in the same aperture into the reservoir.

7. A device according to claim 6, wherein the aperture is elongate in the vertical direction.

8. A device according to claim 6, wherein the aperture of the device has a maximum dimension of at least 1 mm and preferably 3 mm.

9. A device according to claim 1, wherein the emanator pad vaporises the substance into a chamber, the chamber having at least one aperture to the atmosphere, wherein the size of the at least one aperture is such that a saturated vapour of the substance is formed in the chamber so that the rate of emission of the substance from the chamber is critically determined by the size of the at least one aperture.

10. A device according to claim 1, wherein the device is an air freshening device.

11. A method of freshening the air in a room comprising activating an air freshening device according to claim 10 in the room to vaporise the substance in the room.

12. A method of dispensing a vaporisable liquid substance from a sealed reservoir containing the substance, the method comprising the steps of flowing the substance from the reservoir, allowing air into the reservoir through an air inlet to promote the flow of the substance from the reservoir, and conveying at least a portion of the substance which has left the reservoir to the air inlet to block the flow of air into the reservoir through the air inlet and prevent further flow of the substance from the reservoir.

13. A device according to claim 1, wherein the device is a pest control device.

14. A method of controlling pests comprising activating a pest control device according to claim 13 to vaporise the substance.
